(19) United States
(12) Patent Application Publication
(10) Pub. No.: US 2009/0072099 A1
(43) Pub. Date: Mar. 19, 2009

(54) CLAMP ASSEMBLY

(76) Inventors: JASON K. TROTTER, Des Plaines, IL (US); Robert K. Dutzi, Palatine, IL (US); Dennis M. Mark, Buffalo Grove, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/137,728

(22) Filed: Jun. 12, 2008

Related U.S. Application Data
(60) Provisional application No. 60/973,650, filed on Sep. 19, 2007.

(51) Int. Cl. F16L 3/08

(52) U.S. Cl. 248/74.1

(57) ABSTRACT

Embodiments of the present invention provide a clamp assembly configured to securely clamp a tubular member to a structure. The clamp assembly includes a bracket configured to secure to the structure, and an inner bushing integrally connected to the bracket. The bracket and the inner bushing are pre-assembled together as a single unit.

### RELATED APPLICATIONS

This application relates to and claims priority benefits from U.S. Provisional Patent Application No. 60/973,650 entitled “Clamp,” filed Sep. 19, 2007, which is hereby incorporated by reference in its entirety.

### FIELD OF EMBODIMENTS OF THE INVENTION

Embodiments of the present invention generally relate to a clamp assembly, and more particularly to a clamp assembly that may be used to secure a bar, tube or the like to a frame of a vehicle.

### BACKGROUND

In order to secure components, such as bars, tubes, conduits and the like, to a frame of a vehicle, clamps may be used. FIG. 1 illustrates an isometric view of a conventional clamp 10 used to secure a tubular member 12, such as a bar, tube or the like, to a frame 14. The clamp 10 includes a bushing 16 over the tubular member 12 and a bracket 18 that compressively secures the bushing 16 over the member 12 through fasteners 20.

FIG. 2 illustrates an isometric view of the bushing 16 being spread over the tubular member 12. In order to position the bushing 16 on the tubular member 12, a bottom of the bushing 16 is positioned over the tubular member 12. The bottom of the bushing 16 typically includes a slit (not visible in FIG. 2), that is connected to an interior channel 22. As the bushing 16 is urged onto the tubular member 12, the slit opens and the bushing 16 spreads apart until the tubular member 12 enters the interior channel 22. At this point, the bushing 16 may snap back to its at-rest position so that a portion of tubular member 12 is retained within the interior channel 22.

FIG. 3 illustrates an isometric view of the bushing 16 retaining a portion of the tubular member 12 within the interior channel 22. Once the bushing 16 is positioned such that the portion of the tubular member 12 is securely retained within the interior channel 22, the bracket 18 (shown in FIG. 1) is positioned over the bushing 16.

FIG. 4 illustrates an isometric view of the bracket 18 being positioned over the bushing 16. The bracket 18 includes a main curved strap 24 integrally connected to two flat feet 26 at either end. The feet 26 include fastener through holes 28 configured to receive fasteners that are used to securely fasten the bushing 16 to a frame.

FIG. 5 illustrates an isometric view of the bracket 18 positioned over the bushing 16. In order to securely fasten the bushing 16 to the frame, and therefore secure the tubular member 12 in place with respect to the frame, fasteners, such as bolts, are positioned within the fastener through holes 28 of the feet and tightened.

The bushing clamp 10 is cumbersome to assemble. For example, spreading the bushing 16 open over the tubular member 12 and aligning and securing the bracket 18 over the bushing 16 represents a multiple step assembly process. Also, the bushing 16 and brackets 18 are separate and distinct components, and, as such, a manufacturer separately forms and stocks each component. Further, an end user may lose or misplace each separate and distinct component.

### SUMMARY OF EMBODIMENTS OF THE INVENTION

Embodiments of the present invention provide a clamp assembly configured to securely clamp a tubular member, such as a stabilizer bar of a suspension system, to a structure, such as a vehicle frame. The clamp assembly includes a bracket configured to secure to the structure, and an inner bushing integrally connected to the bracket. The bracket and the inner bushing are integrally formed as a single unit. For example, the bracket and the inner bushing may be pre-assembled together as a single unitary piece.

The bracket may be coiled and may include a first fastening tab connected to a first C beam that is, in turn, connected to an intermediate cross beam that is, in turn, connected to a second C beam that is, in turn, connected to a second fastening tab, wherein an insertion gap is defined between the first and second C beams. The clamp assembly may be positioned on the tubular member through the intermediate gap, and may then be rotated 90° with respect to the tubular member into a clamping position.

The first and second fastening tabs may each include a fastener through hole. The fastener through holes may be aligned on an axis of the clamp assembly in order to allow the clamp assembly to be retrofit to existing structures that previously used conventional clamps.

Each of the first and second fastening tabs may include a protuberance configured to snapably secure into a hole formed through the structure. Optionally, the first and second fastening tabs may include upturned ends configured to latchably secure to a strap of the structure. Also, alternatively, each of the fastening tabs may include a slotted distal end configured to engage a pre-assembled fastener positioned on the structure.

The bracket may include a door pivotally secured to a hinge. The door may be pivoted between open and closed positions through the hinge, and wherein a portion of the bushing is secured to the door.

The clamp assembly may also include a low friction liner secured to the bushing. The low friction liner is configured to contact the tubular member.

The bushing of the clamp assembly may also include an inner lining that dampens vibrations and noise and insulates the clamp assembly, and a rigid core.

Certain embodiments of the present invention provide a clamp assembly configured to securely clamp a stabilizer bar of a suspension system to a vehicle frame. The clamp assembly may include a bracket, an inner bushing, and a low friction liner.

The bracket is configured to secure to the vehicle frame. The inner bushing integrally connects to the bracket. The bracket may include a rigid core and a bracket channel that securely retains the bracket. The bracket and the inner bushing are pre-assembled together as a single unit.

The low friction liner secures to the bushing and is configured to contact a portion of the stabilizer bar. One or both of the inner bushing and/or the low friction liner dampen vibrations and noise and insulate the clamp assembly.

### BRIEF DESCRIPTION OF SEVERAL VIEWS OF THE DRAWINGS

FIG. 1 illustrates an isometric view of a conventional clamp used to secure a tubular member to a frame.

FIG. 2 illustrates an isometric view of a conventional bushing being spread over a tubular member.

FIG. 3 illustrates an isometric view of a conventional bushing retaining a portion of a tubular member within an interior channel.

FIG. 4 illustrates an isometric view of a conventional bracket being positioned over a conventional bushing.

FIG. 5 illustrates an isometric view of a conventional bracket positioned over a conventional bushing.

FIG. 6 illustrates an isometric view of a clamp assembly, according to an embodiment of the present invention.

FIG. 7 illustrates an isometric view of a clamp assembly being initially positioned with respect to a bar, according to an embodiment of the present invention.

FIG. 8 illustrates an isometric view of a clamp assembly being rotated into a clamping position with respect to a bar, according to an embodiment of the present invention.

FIG. 9 illustrates an isometric view of a clamp assembly in a clamping position with respect to a bar, according to an embodiment of the present invention.

FIG. 10 illustrates a cross sectional view of a clamp assembly, according to an embodiment of the present invention.

FIG. 11 illustrates a top view of a clamp assembly securing a bar to a frame, according to an embodiment of the present invention.

FIG. 12 illustrates an isometric view of a fastening tab of a clamp assembly, according to an embodiment of the present invention.

FIG. 13 illustrates a cross-sectional view of a fastening tab securing to a frame through line 13-13 of FIG. 11, according to an embodiment of the present invention.

FIG. 14 illustrates a top view of a clamp assembly securing a bar to a frame, according to an embodiment of the present invention.

FIG. 15 illustrates an isometric view of a fastening tab of a clamp assembly, according to an embodiment of the present invention.

FIG. 16 illustrates a top view of a clamp assembly, according to an embodiment of the present invention.

FIG. 17 illustrates a top view of a clamp assembly in an initial mounting position, according to an embodiment of the present invention.

FIG. 18 illustrates a cross-sectional view of a frame having a pre-assembled bolt, according to an embodiment of the present invention.

FIG. 19 illustrates a top view of a clamp assembly being moved into a clamping position, according to an embodiment of the present invention.

FIG. 20 illustrates a top view of a clamp assembly in a clamping position, according to an embodiment of the present invention.

FIG. 21 illustrates a cross-sectional view of a fastening tab positioned relative to a pre-assembled bolt, according to an embodiment of the present invention.

FIG. 22 illustrates a cross-sectional view of a tightened pre-assembled bolt with respect to a fastening tab, according to an embodiment of the present invention.

FIG. 23 illustrates an isometric view of a clamp assembly, according to an embodiment of the present invention.

FIG. 24 illustrates an isometric view of a clamp assembly, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

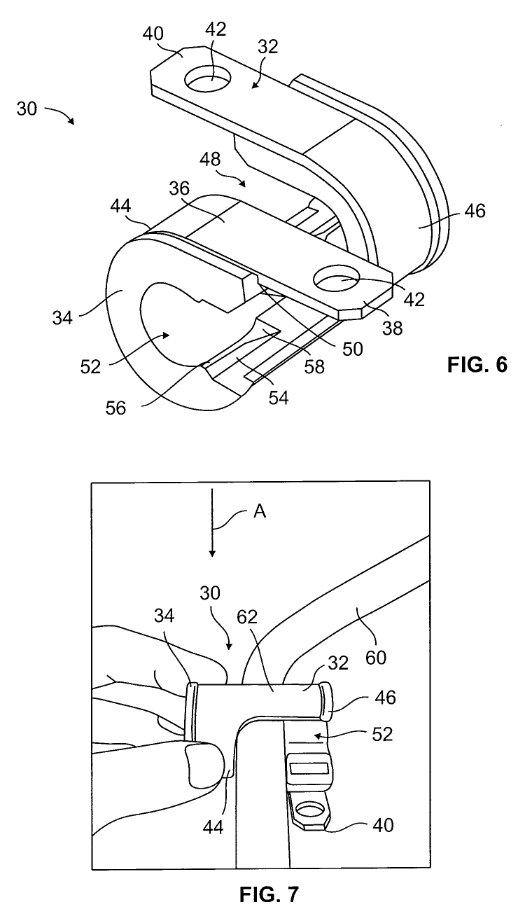

FIG. 6 illustrates an isometric view of a clamp assembly 30, according to an embodiment of the present invention. The clamp assembly 30 includes a bracket 32 integrally connected to a bushing 34. That is, the bracket 32 and the bushing 34 are manufactured as a single piece. Thus, an end user does not separately fasten the bracket 32 to the bushing 34.

The bracket 32 includes a single, unitary main body 36 formed of metal, such as steel. The main body 36 is bent and curved to wrap around the bushing 34 in a coiling fashion. That is, the main body 36 wraps around the bushing 34. Flat fastening tabs 38 and 40 having fastener through holes 42 formed therethrough are connected to ends of the main body 36. The tabs 38 and 40 extend away from opposite sides of the clamp assembly 30.

The flat tab 38 extends and connects to a curved C beam 44 that wraps around the bushing 34 such that it connects to an intermediate cross-beam (positioned underneath the bushing 34 in FIG. 6) that connects to curved C beam 46 at the opposite end of the bushing 34. Instead of an intermediate cross beam that angles from a lower end of the C beam 44 to a lower end of the C beam 46, the bottom of the bracket 32 may be a semi-cylindrical panel that connects the C beams 44 and 46 together.

The intermediate cross-beam separates the C beams 44 and 46, thereby forming a bar insertion gap 48 therebetween. The C-bar 46 connects to the flat tab 40.

An outer surface of the bushing 34 generally conforms to an inner surface of the bracket 32. That is, the bushing 34 includes a bracket channel 50 that securely retains the bracket 32. The bracket 32 may be snapably secured within the bracket channel 50. Optionally, the bracket 32 may be bonded, glued or otherwise fastened within the bracket channel 50.

The bracket assembly 30 defines a bar channel 52 through a longitudinal length thereof. The bar channel 52 is open at one side through an open end of the C beam 44 and open at the opposite side through an open end of the C beam 46. The bar channel 52 is open on both sides between the C beams 44 and 46. That is, the C beam 44 and the bushing 34 are configured to abut one side of a tubular member, while the C beam 46 and the bushing 34 are configured to abut an opposite side of the tubular member, while both sides of the tubular member are exposed between the C beams 44 and 46 (but the intermediate cross beam and bushing 34 support an underside of the tubular member).

The bushing 34 includes molded ribs 54 longitudinally aligned within the bar channel 52. The ribs 54 extend upwardly from the bushing 34 within the bar channel 52 proximate opposite ends of the bushing 34. The ribs 54 extend toward the center of the bushing 34. As shown in FIG. 6, each rib 54 includes a raised ridge 56 that tapers down and flattens toward the center of the bushing 34, terminating in a beveled ramp 58 that flattens out. The bushing 34 may include more ribs 54 than those shown.

The ribs 54 are configured to securely retain the tubular member within the bar channel 52. The flattened ramps 58 allow the tubular member to be swung into position, while the raised ridges 56 securely lock the tubular member within the bar channel 52.

The winding, curved, coiled configuration of the clamp assembly 30 allows it to be swung into position over a tubular member. Also, because the clamp assembly 30 is formed as a single, unitary piece including the bracket 32 and the bushing 34, the assembly process is easier and simpler than with respect to prior designs.

FIG. 7 illustrates an isometric view of the clamp assembly 30 being initially positioned with respect to a bar 60, according to an embodiment of the present invention. In order to position the clamp assembly 30 on the bar 60, the insertion gap 48 is aligned with the bar 60. The clamp assembly 30 is then moved toward the bar in the direction of arrow A until the intermediate cross beam 62 abuts the bar 60. In this position, the bar 60 is perpendicular to the bar channel 52 and is positioned between the C beams 44 and 46 and the intermediate cross beam 62.

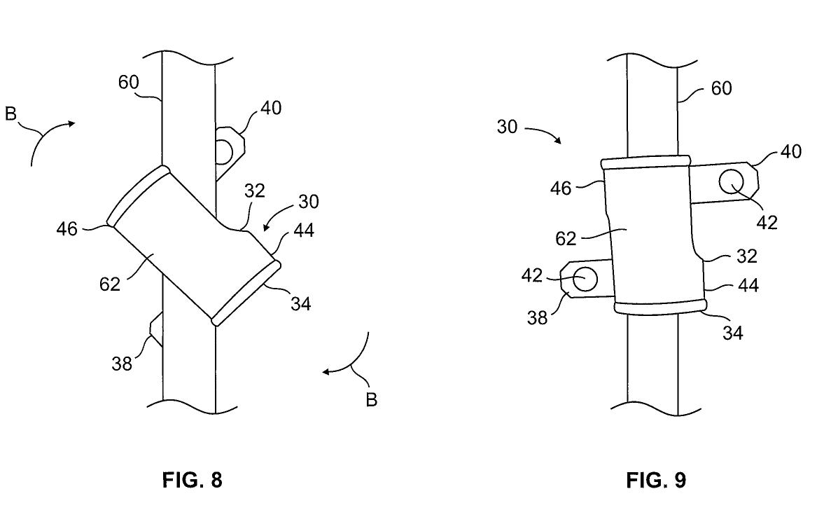

FIG. 8 illustrates an isometric view of the clamp assembly 30 being rotated into a clamping position with respect to the bar 60, according to an embodiment of the present invention. In order to position the clamp assembly 30 into a bar clamping position, the clamp assembly 30 is rotated 90° in the direction of arcs B. The open ends of the C beams 44 and 46 allow the bar to pass into and align with the bar channel 52. The closed ends of the C beams 44 and 46 prevent further rotational movement of the clamp assembly 30 with respect to the bar 60.

FIG. 9 illustrates an isometric view of the clamp assembly 30 in a clamping position with respect to the bar 60, according to an embodiment of the present invention. The clamp assembly 30 has been fully rotated into a clamping position such that one side of the bar 60 abuts into the bushing 34 proximate the C beam 44, while the opposite side of the bar 60 abuts into the bushing 34 proximate the C beam 46. The bar channel 52 (shown in FIG. 6) is longitudinally aligned with the bar 60 and the ribs 54 (shown in FIG. 6) align and secure the bar 60 within the bar channel 52. In this position, fasteners, such as bolts, may be positioned through the fastener through holes 42 to secure the bar 60 with respect to a frame, such as an interior frame of a vehicle.

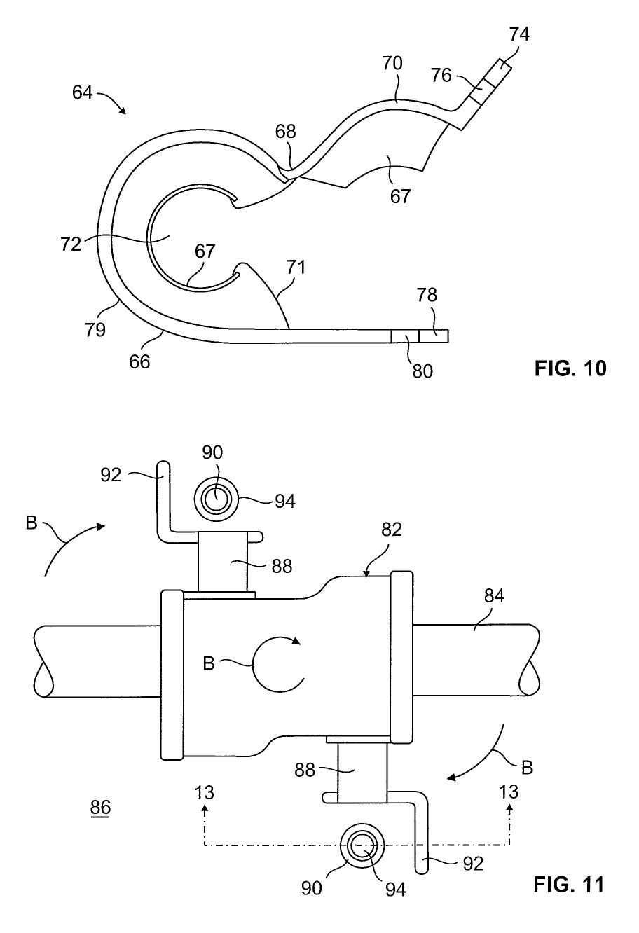

FIG. 10 illustrates a cross sectional view of a clamp assembly 64, according to an embodiment of the present invention. The clamp assembly 64 includes a bracket 66 integrally assembled with a bushing 67. The brackets 66 may include a hinge 68 connected to a door 70. The door 70 may be pivoted into an open and closed position about the hinge 68. The door 70 includes a portion of the bushing 67 secured to an interior surface thereof. Further, the bushing 67 includes a rib 71, as described above.

When opened, the clamp assembly 64 may be moved over a bar. When the bar is located within a bar channel 72, the door 70 is rotated into a closed position about the hinge 68. In the closed position, a tab 74 having a through hole 76 is aligned over a tab 78 connected to a main body 79 of the clamp assembly 64. In this position, the through hole 76 is aligned with a through hole 80 of the tab 78. A fastener, such as a bolt, may be positioned through the through holes 76 and 80 in order to securely fasten the door 70 to the main body 79, and secure the clamp assembly 64 and the bar to a frame. Thus, the clamp assembly 64 includes a unitary assembly having the bracket 66 integrally connected to the bushing 67, and which may quickly and easily secure a bar to a frame.

The clamp assembly 64 may be a contiguous cylindrical piece when the door 70 is closed, or it may be wound and coiled similar to the clamp assembly 30 (shown in FIGS. 6-9). Also, the clamp assembly 64 may include multiple hinges and doors.

FIG. 11 illustrates a top view of a clamp assembly 82 securing a bar 84 to a frame 86, according to an embodiment of the present invention. The clamp assembly 82 is similar to the clamp assembly 30 (shown in FIGS. 6-9) except that the fastening tabs 88 include buttons or other such protuberances 90, instead of through holes.

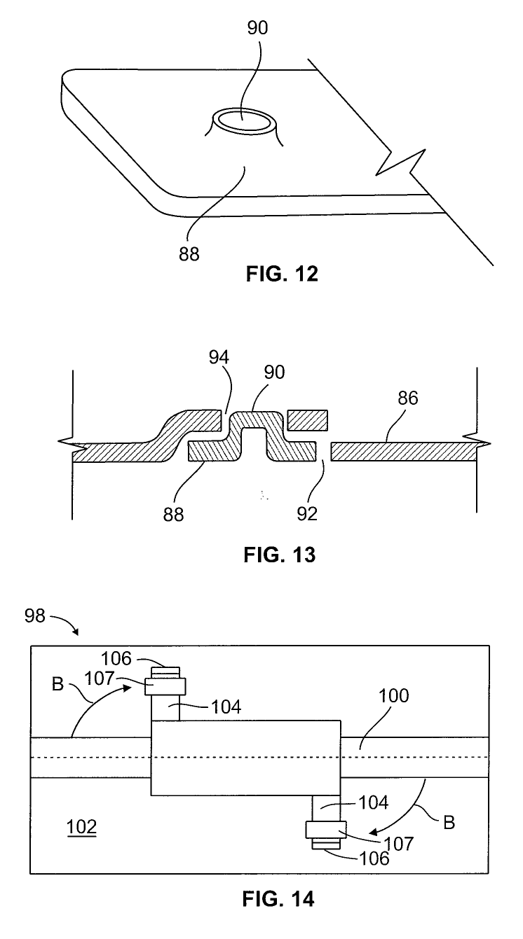

FIG. 12 illustrates an isometric view of a fastening tab 88 of the clamp assembly 82 (shown in FIG. 11). FIG. 13 illustrates a cross-sectional view of the fastening tab 88 securing to the frame 86 through line 13-13 of FIG. 11. Referring to FIGS. 11-13, as the clamp assembly 82 is rotated into a clamping position, the fastening tabs 88 pass into L-shaped slots 92 formed through the frame 86. The clamp assembly 82 continues to be moved in the direction of arrows B until the protuberances 90 encounter reciprocal holes 94 formed through the frame 86, at which point the protuberances 90 snap into the holes 94, thereby securing the clamp assembly 82 in position. Thus, the clamp assembly 82 may secure the bar 84 to the frame 86 without the use of separate and distinct fasteners, such as bolts.

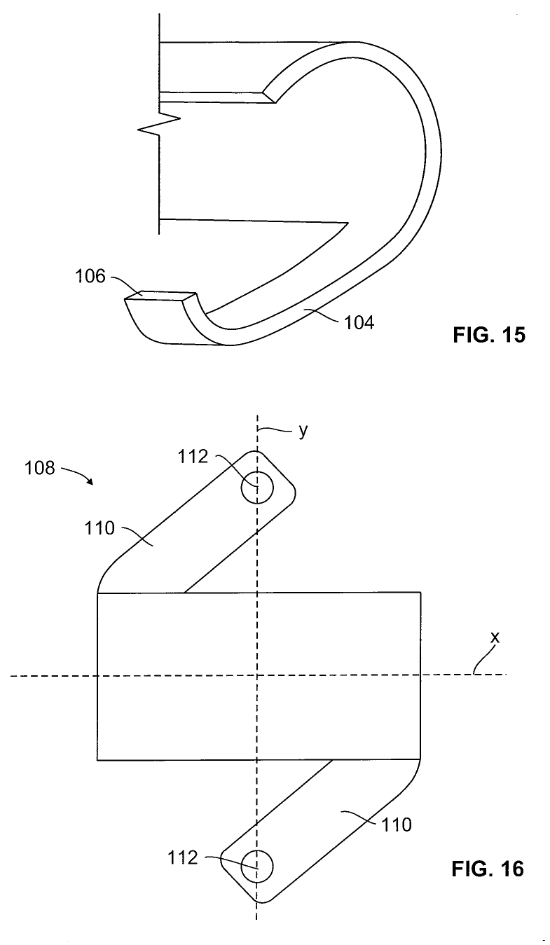

FIG. 14 illustrates a top view of a clamp assembly 98 securing a bar 100 to a frame 102, according to an embodiment of the present invention. FIG. 15 illustrates an isometric view of a fastening tab 104 of the clamp assembly 98. Referring to FIGS. 14 and 15, the clamp assembly 98 is similar to the clamp assemblies 30 and 82 described above, except that the fastening tabs 104 include upturned ends 106 that latchably secure to straps 107 formed on the frame 102. Thus, the clamp assembly 98 may be secured to the frame 102 without the use of separate and distinct fasteners.

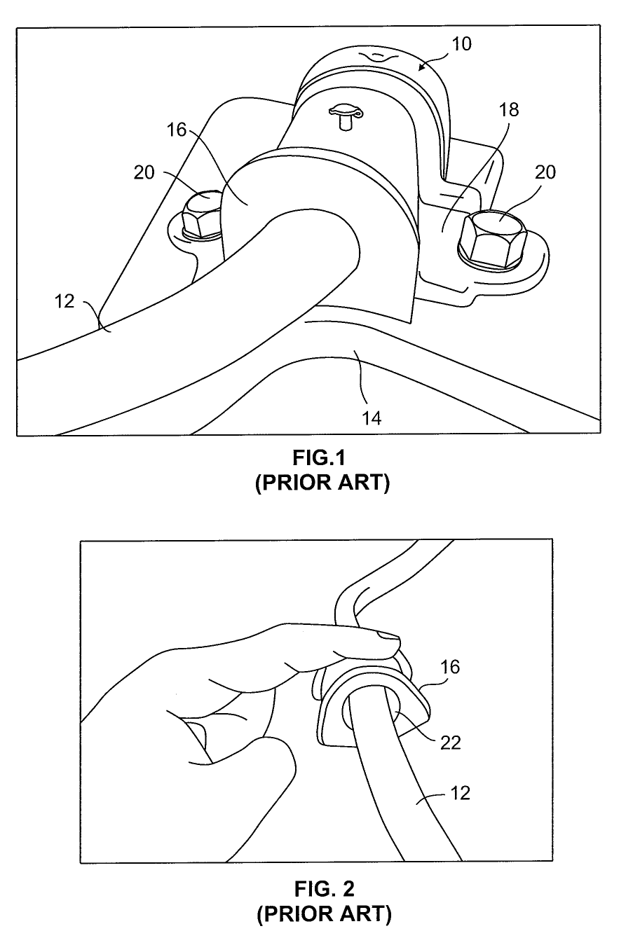

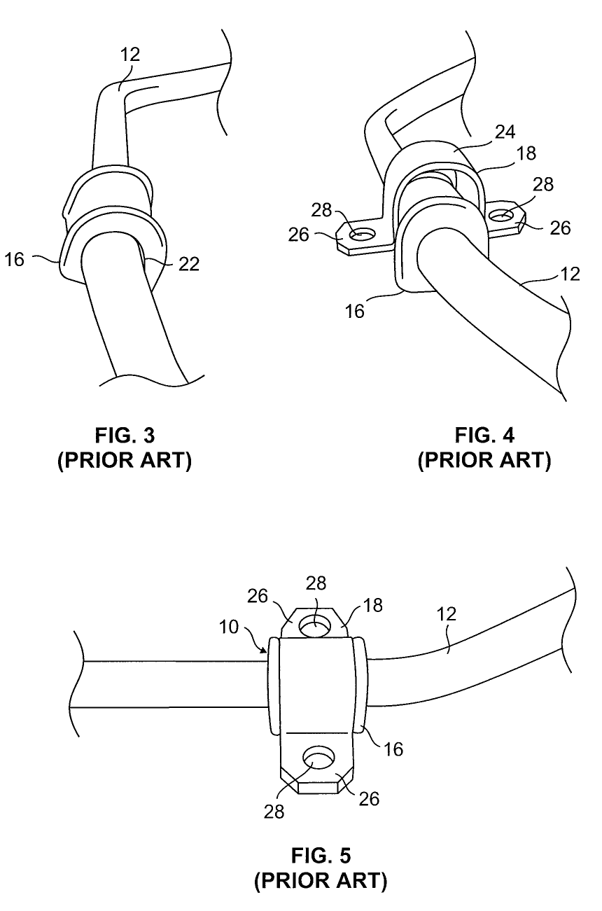

FIG. 16 illustrates a top view of a clamp assembly 108, according to an embodiment of the present invention. The clamp assembly 108 is similar to the clamp assembly 30 (shown in FIGS. 6-9), except that the fastening tabs 110 are inwardly angled toward a lateral axis y that is perpendicular to a longitudinal axis x. The fastening tabs 110 are angled such that the through holes 112 are aligned with the lateral axis y of the clamp assembly 108. This orientation allows the clamp assembly 108 to replace conventional clamps, such as shown in FIG. 1, that include aligned feet and through holes.

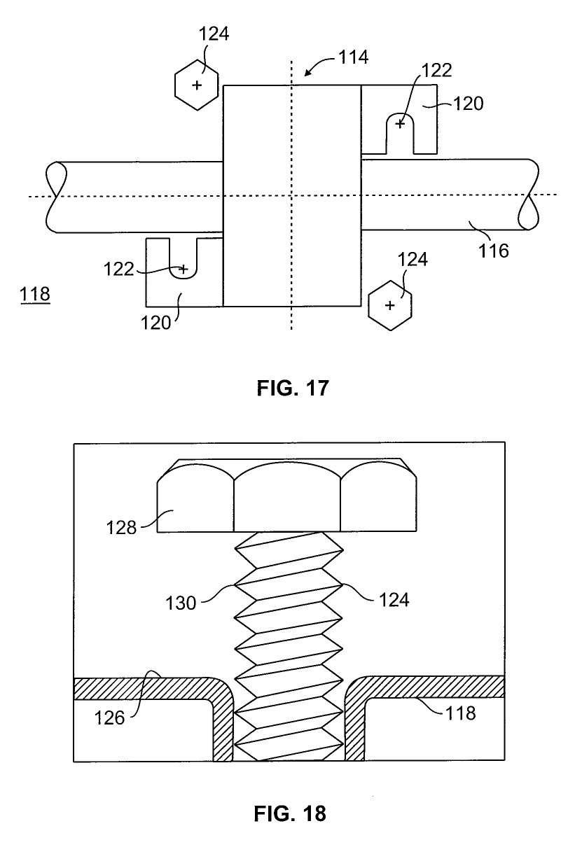

FIG. 17 illustrates a top view of a clamp assembly 114 in an initial mounting position with respect to a bar 116 and a frame 118, according to an embodiment of the present invention. The clamp assembly 114 is similar to the clamp assembly 30 (shown in FIGS. 6-9), except that the fastening tabs 120 include inwardly-directed fastener slots 122 configured to engage pre-assembled bolts 124 positioned on the frame 118.

FIG. 18 illustrates a cross-sectional view of the frame 118 having a pre-assembled bolt 124 extending upwardly therefrom. As shown in FIG. 18, the bolt 124 is not tightened to the surface 126 of the frame 118. Instead, the head 128 of the bolt 124 is suspended above the surface 126, thereby exposing the threaded shaft 130.

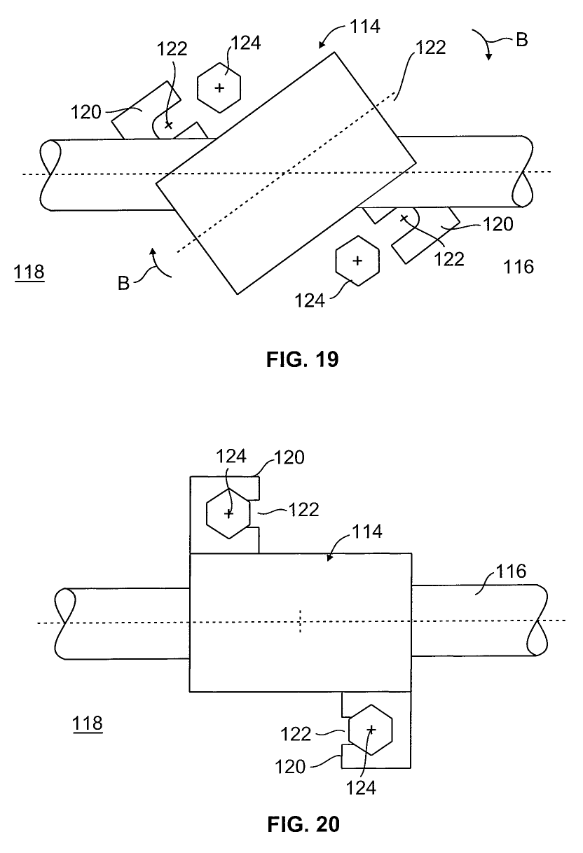

FIG. 19 illustrates a top view of the clamp assembly 114 being moved into a clamping position. FIG. 20 illustrates a top view of the clamp assembly 114 in a clamping position, in which the clamp assembly 114 securely fastens the bar 116 to the frame 118.

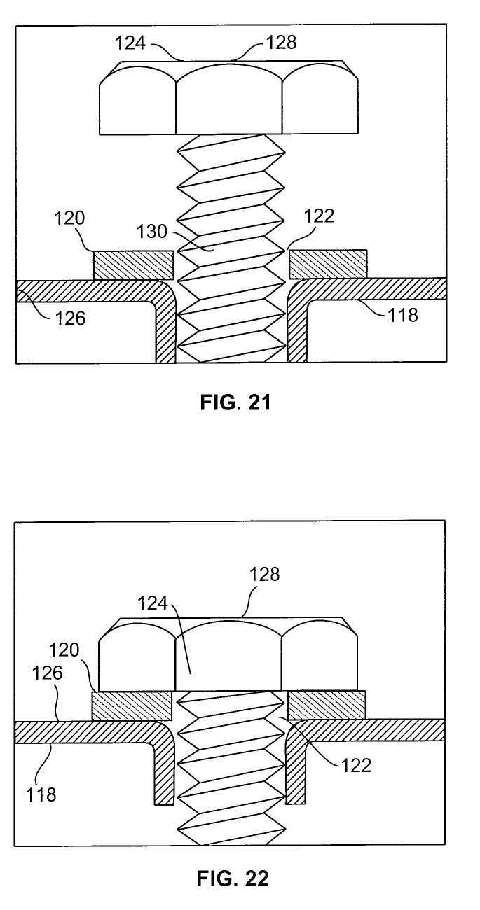

FIG. 21 illustrates a cross-sectional view of the fastening tab 120 positioned relative to the pre-assembled bolt 124. When the clamp assembly 114 (shown in FIGS. 17 and 19-20) is moved into the clamping position (as shown in FIG. 20), the fastening tabs 120 are moved into the bolts 124 such that a portion of each shaft 130 of the bolt 124 is within the fastener slot 122. In this position, distal ends of the fastener tabs 120 are positioned between the head 128 of the bolt 124 and the surface 126 of the frame 118.

FIG. 22 illustrates a cross-sectional view of a tightened pre-assembled bolt 124 with respect to the fastening tab 120. The bolt 124 is tightened to compressively sandwich the distal ends of the fastener tabs 120 between the bolt head 128 and the surface 126 of the frame 118. In this manner, the clamp assembly of FIGS. 17 and 19-20 securely fastens the bar 16 to the frame 118.

FIG. 23 illustrates an isometric view of a clamp assembly 140, according to an embodiment of the present invention. The clamp assembly 140 is similar to the clamp assembly 30 (shown in FIGS. 6-9), except that the clamp assembly 140 includes a low friction liner 142 exposed within the bar channel 144. That is, the bar abuts against the low friction liner 142, instead of directly against the bushing 146. As shown, the bushing 146 is sandwiched between the bracket 148 and the liner 144. The liner 144 may be formed of any low-friction material, such as Teflon. Also, the liner 144 and/or the bushing 146 may be coated with a low-friction coating. The low friction liner 144 provides a low friction interface between the clamp assembly 140 and the bar, thereby protecting the clamp assembly 140 and the bar from scratches or other damage.

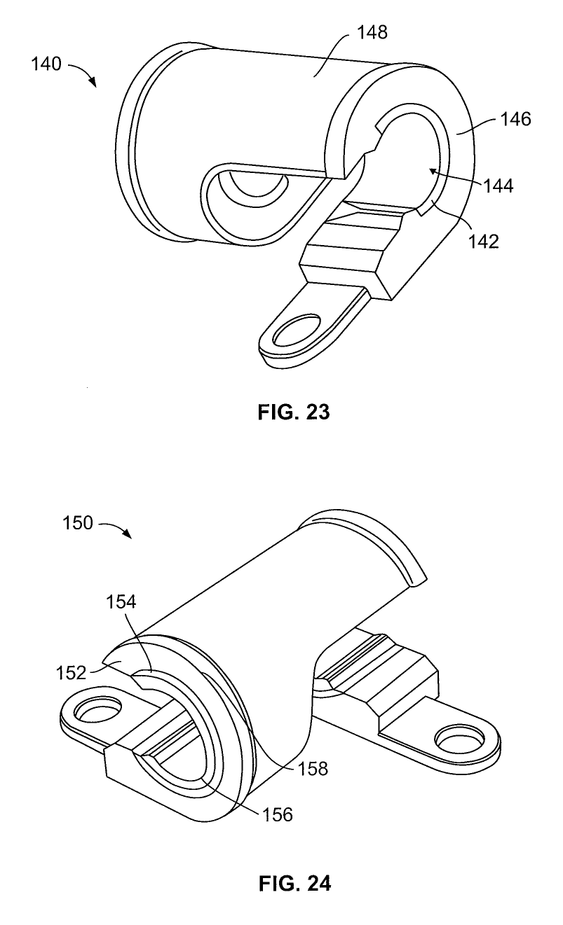

FIG. 24 illustrates an isometric view of a clamp assembly 150, according to an embodiment of the present invention. The clamp assembly 150 is similar to the clamp assembly 30 (shown in FIGS. 6-9), except that the bushing 152 includes a rigid core 154, which may be formed of steel or hard plastic, that adds strength and stability to the clamp assembly 150. The bushing 150 may also include an inner lining 156 that is configured to dampen vibrations and noise, and insulate the clamp assembly 150. The inner lining 156 is formed of a material, such as rubber, that is capable of absorbing and dampening noise and vibration, while at the same time insulating the clamp assembly 150. Additionally, the outer surface 158 of the bushing 152 may be formed of a high rate elastomer to further dampen vibrations and noise, while at the same time insulating the clamp assembly 150.

Embodiments of the present invention provide a clamp assembly that is easily installed with respect to a bar and frame. The unitary bracket and bushing design allows a user to simply rotate the clamp assembly into a clamping position. The bushing may be adhered to the bracket (e.g., through an adhesive such as glue), assembled to the bracket before shipping, or integrally molded to or with the bracket. For an overmold application, a heat based adhesive may be used and applied to the bracket to aid in bonding, then the bracket can be placed into a mold with the bushing molding around or to the bracket.

Embodiments of the present invention provide brackets that are formed as a single piece out of flat steel. The steel is wound about a mandrel to create a curly, coiled shape.

Embodiments of the present invention provide bushings that have some degree of springiness or flexibility, such that the edges defining the bracket channels tend to wrap around the outer edges of the brackets.

Embodiments of the present invention may be used to secure stabilizer bars in automobile suspension systems to vehicle frames. The stabilizer bar acts as a torsion spring to provide vehicle stability while cornering. The bushings described above may be made of a rubber material, such as urethane, and the bracket may be formed of low carbon steel.

Embodiments of the present invention provide clamp assemblies having less parts than prior clamps. Because the clamp assembly is a unitary piece having the bushing integrally formed with the bracket, the installation process for an end user is simpler than with prior designs that required a user to separately attach a bracket over the bushing. Embodiments of the present invention provide a preassembled single unit, instead of separate and distinct brackets and bushings.

Further, embodiments of the present invention provide clamp assemblies that eliminate the need to spread a bushing over a bar, as in prior designs, thereby allowing for stiffer bushings to be used with better ergonomics. Also, because the clamp assemblies are rotated into position, a user may install the clamp assemblies into a clamping position with one hand. In general, the installation process for an end user is easier than with prior designs.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A clamp assembly configured to securely clamp a tubular member to a structure, the clamp assembly comprising:
a bracket configured to secure to the structure; and
an inner bushing integrally connected to said bracket, said bracket and said inner bushing being pre-assembled together as a single unit.

2. The clamp assembly of claim 1, wherein said bracket is coiled and comprises a first fastening tab connected to a first C beam that is, in turn, connected to an intermediate cross beam that is, in turn, connected to a second C beam that is, in turn, connected to a second fastening tab, wherein an insertion gap is defined between said first and second C beams.

3. The clamp assembly of claim 1, wherein the clamp assembly is rotated 90° with respect to the tubular member into a clamping position.

4. The clamp assembly of claim 2, wherein each of said first and second fastening tabs comprises a fastener through hole.

5. The clamp assembly of claim 4, wherein said fastener through holes are aligned on an axis of the clamp assembly.

6. The clamp assembly of claim 2, wherein each of said first and second fastening tabs comprises a protuberance configured to snapably secure into a hole formed through the structure.

7. The clamp assembly of claim 2, wherein each of said first and second fastening tabs comprises an upturned end configured to latchably secure to a strap of the structure.

8. The clamp assembly of claim 2, wherein each of said first and second fastening tabs comprises a slotted distal end configured to engage a pre-assembled fastener positioned on the structure.

9. The clamp assembly of claim 1, wherein said bracket comprises a door pivotally secured to a hinge, wherein said door may be pivoted between open and closed positions through said hinge, and wherein a portion of said bushing is secured to said door.

10. The clamp assembly of claim 1, comprising a low friction liner secured to said bushing, wherein said low friction liner is configured to contact the tubular member.

11. The clamp assembly of claim 1, wherein said bushing comprises an inner lining that dampens vibrations and noise and insulates the clamp assembly.

12. The clamp assembly of claim 1, wherein said bushing comprises a rigid core.

13. A clamp assembly configured to securely clamp a stabilizer bar of a suspension system to a vehicle frame, the clamp assembly comprising:
a bracket configured to secure to the vehicle frame;
an inner bushing integrally connected to said bracket, said bracket comprising a rigid core and a bracket channel that securely retains said bracket, said bracket and said inner bushing being pre-assembled together as a single unit; and
a low friction liner secured to said bushing, said low friction liner being configured to contact a portion of the stabilizer bar, wherein one or both of said inner bushing and/or said low friction liner dampen vibrations and noise and insulate the clamp assembly.

14. The clamp assembly of claim 13, wherein said bracket is coiled and comprises a first fastening tab connected to a first C beam that is, in turn, connected to an intermediate cross beam that is, in turn, connected to a second C beam that is, in turn, connected to a second fastening tab, wherein an insertion gap is defined between said first and second C beams.

15. The clamp assembly of claim 13, wherein the clamp assembly is rotated 90° with respect to the portion of the stabilizer bar into a clamping position.

16. The clamp assembly of claim 14, wherein each of said first and second fastening tabs comprises a fastener through hole.

17. The clamp assembly of claim 16, wherein said fastener through holes are aligned on an axis of the clamp assembly.

18. The clamp assembly of claim 14, wherein each of said first and second fastening tabs comprises a protuberance configured to snapably secure into a hole formed through the vehicle frame.

19. The clamp assembly of claim 14, wherein each of said first and second fastening tabs comprises an upturned end configured to latchably secure to a strap of the vehicle frame.

20. The clamp assembly of claim 14, wherein each of said first and second fastening tabs comprises a slotted distal end configured to engage a pre-assembled fastener positioned on the vehicle frame.

21. The clamp assembly of claim 14, wherein said bracket comprises a door pivotally secured to a hinge, wherein said door may be pivoted between open and closed positions through said hinge, and wherein a portion of said bushing is secured to said door.

22. A clamp assembly configured to securely clamp a stabilizer bar of a suspension system to a vehicle frame, the clamp assembly comprising:
a bracket configured to be securely fastened to the vehicle frame, wherein said bracket comprises a first fastening tab connected to a first C beam that is, in turn, connected to an intermediate cross beam that is, in turn, connected to a second C beam that is, in turn, connected to a second fastening tab, wherein an insertion gap is defined between said first and second C beams;
a bushing integrally connected to said bracket, said bracket comprising a rigid core and a bracket channel that securely retains said bracket; and
a low friction liner secured to said bushing, said low friction liner being configured to contact a portion of the stabilizer bar, wherein one or both of said inner bushing and/or said low friction liner dampen vibrations and noise, and insulate the clamp assembly,
wherein the clamp assembly is rotated 90° with respect to the portion of the stabilizer bar into a clamping position.

23. The clamp assembly of claim 22, wherein said bracket and said bushing are pre-assembled together as a single unit
